(19) United States
(12) Patent Application Publication
(10) Pub. No.: US 2012/0024556 A1
(43) Pub. Date: Feb. 2, 2012

(54) Three-in-one air tool

(76) Inventor: Shiqi Zhu, Ashland, VA (US)

(21) Appl. No.: 12/805,366

(22) Filed: Jul. 27, 2010

(51) Int. Cl. B25F 3/00

(52) U.S. Cl. 173/218

(57) ABSTRACT

A three-in-one pneumatic tool combining interchangeable tool heads with a standard pneumatic rotary drive assembly. The system includes drill, die grinder, and ratchet tool heads that may be attached/detached as desired from a pneumatic drive assembly. A quick-release coupling mounted at the mating end of the pneumatic drive assembly allows the user to easily insert the corresponding mating end of the various tool heads into the pneumatic drive so they may then be used in the same manner as their more traditional versions.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to a pneumatic tool with interchangeable tool heads. More specifically, this invention relates to a combination pneumatic tool wherein the functionality of multiple tools is duplicated using easily interchangeable tool heads that may be quickly exchanged as desired. No additional tools are required in order to perform the operation, the hand strength and dexterity possessed by the average adult is sufficient.

### BACKGROUND OF THE INVENTION

Compressed gasses, usually in the form of compressed air, have long been used to provide motive power for hand tools. At least as early as 1858, Burnell U.S. Pat. No. 21,318 disclosed a fluid-driven “rotary engine” that is usable, for example, as a “steam engine, a water-wheel or a meter.” While such fluid-driven devices continue to be common, ostensibly the most common “fluid” now used in such apparatuses is compressed air, or in some cases, compressed nitrogen. Typically, the compressed gas is injected into a chamber wherein it causes rotational movement of a rotor/impeller. Power produced at the axle of the rotor/impeller is then coupled to various rotating tools to perform, for example, cutting-, drilling-, or grinding-type operations. These pneumatically-powered tools can be used in essentially any role in which an electric motor may be used, with the advantage that they are often simpler and less expensive to manufacture, more durable, and lighter/smaller compared to their electrically powered counterparts. Nonetheless, pneumatic tools are expensive and their manufacture is labor intensive. Moreover, since the tools must be attached by a hose to their compressed air supply, utilizing multiple tools for a task typically entails an unnecessarily laborious process wherein the user must remove the hose from the tool he/she no longer needs and thereafter attach it to the now-required tool. Furthermore, the cost of acquiring specific tools for specific jobs is expensive and the acquisition of such tools requires significant storage space.

What is needed therefore is a cost-effective method to quickly switch heads as they are needed using the basic air supply and coupling. Such a device presents cost and space economies and its costs of manufacturing and ownership would be lower compared to traditional tools.

### SUMMARY OF THE INVENTION

The present invention is a three-in-one pneumatic tool uniquely combining interchangeable tool heads with a standard pneumatic rotary drive assembly. In a preferred embodiment, the system includes drill, die grinder, and ratchet tool heads that may be attached/detached as desired from a pneumatic drive assembly. A quick-release coupling mounted at a mating end of the pneumatic drive assembly allows the user to easily insert the corresponding mating end of the desired tool head into the pneumatic drive so that they may then be used in the same manner as their more traditional versions. The system not only saves time when multiple tools are needed to complete a particular task, the system also reduces the costs of both manufacturing the tools and their price to the consumer, with the additional benefit that because the incremental costs of additional tool heads will be lower compared to buying a traditional pneumatic tool, the consumer may be able to afford a wider array of tools than otherwise possible. Furthermore, when breakage occurs only one tool head need be replaced or repaired. Moreover, the tool heads can be upgraded as technological improvements are made, thereby ensuring that the system will never become obsolete.

While in its preferred embodiment, this invention includes drill, die grinder, and ratchet tool heads, this apparatus contemplates use of any tool head utilizing rotational motion, for example, a cut-off tool, circular saw, circular sander, or impact wrench. Additionally, this invention encompasses tools wherein rotational motion may be converted into linear movement, for example, a reciprocating sander or impact hammer/drill/wrench.

It is an object of the invention to provide a pneumatic tool with interchangeable tool heads;

It is yet another object of this invention to provide an interchangeable tool head pneumatic tool wherein no tools are required in order to exchange tool heads;

It is still another object of this invention to provide an interchangeable tool head pneumatic tool wherein typical human hand strength and dexterity are sufficient to exchange tool heads;

It is an object of this invention to provide a pneumatic tool with easily interchangeable tool heads wherein tool heads incorporating new technologies can be accommodated; and,

It is another object of this invention to provide a wide array of pneumatic tools to the consumer at a lower cost.

### BRIEF DESCRIPTION OF THE DRAWINGS

FIG. 1 is an exploded perspective view of the invention showing the pneumatic drive assembly and the ratchet, die grinder, and drill tool heads of the preferred embodiment;

FIG. 2 is a perspective detail view of the mating ends of the pneumatic drive assembly and the tool heads shown in FIG. 1;

FIG. 3 is an enlarged front view showing the pneumatic drive assembly mating end;

FIG. 4 is a cutaway schematic showing the mating end of the pneumatic drive assembly with the mating end of a tool head inserted therein, prior to interlocking;

FIG. 5 is a cutaway schematic showing the mating end of the pneumatic drive assembly with the mating end of a tool head inserted therein as shown in FIG. 4, with mating ends interlocked; and,

FIG. 6 is an exploded perspective view of the mating end of the pneumatic drive assembly.

### DETAILED DESCRIPTION OF THE INVENTION

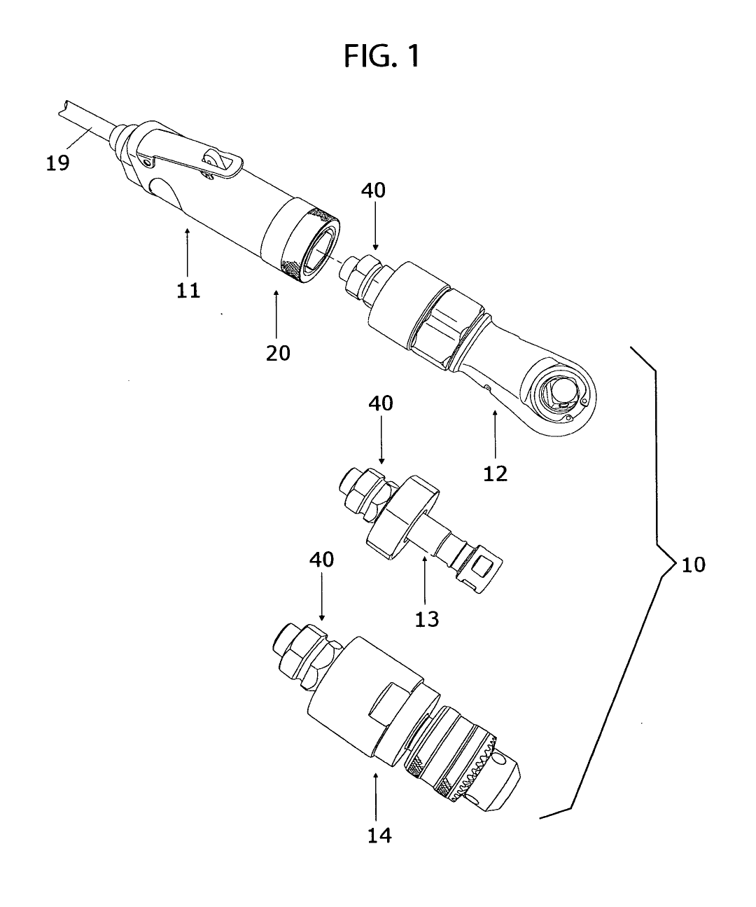

The preferred embodiment and best mode of the invention are shown in FIGS. 1 through 6. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

This invention may be constructed from any sufficiently durable material including carbon steel, stainless steel, aluminum, zinc, other metals, various polymers, ceramics, and combinations thereof.

Turning now to FIG. 1, the preferred tool embodiment 10 is shown, including its pneumatic drive assembly 11, a ratchet tool head 12, a die grinder tool head 13, and a drill tool head 14. The pneumatic drive mating end 20 and the tool head mating ends 40 of each of the tool heads are also shown and are disclosed in detail infra. Also shown is air hose 19 which is connected to a supply of compressed air (not shown) to thereby provide motive power for the apparatus 10. The air hose 19 is mounted to the pneumatic drive assembly 11 in a conventional manner, typically via a threaded fitting of sufficiently compressible metal (e.g., brass) such that an air-tight seal is ensured.

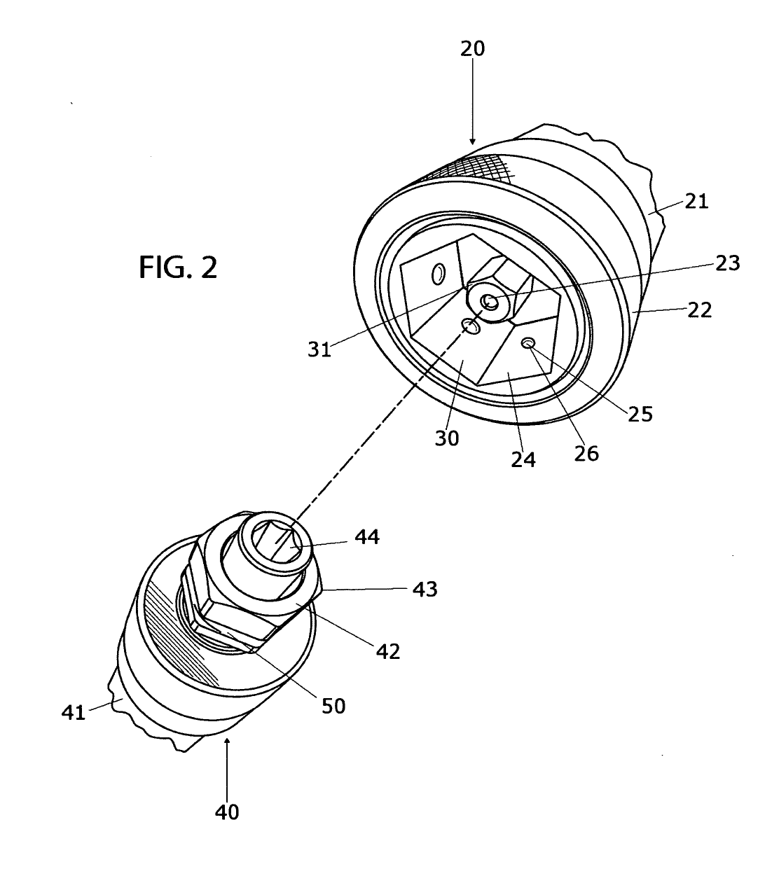

Turning to FIG. 2, the pneumatic drive mating end 20 and tool head mating end 40 are shown in detail. The pneumatic drive mating end 20 is mounted to the distal end 21 of the pneumatic drive assembly 11. A locking ring 22 is mounted at the distal end of the pneumatic drive mating end 20 whereby locking and unlocking of the tool heads are effected. In the preferred embodiment, knurling is applied to the external surface of the locking ring 22 to increase the user's grip when manipulating the tool 10. This invention contemplates any mechanism by which treatments may be applied to the surfaces of the implement 10 to increase friction in areas that will be manipulated by the user, including stipling, acid etching, and the similar. The pneumatic drive mating end 20 has a female end 24 defined by the interior surface 30 of the pneumatic drive mating end 20 sized to accommodate insertion of the corresponding tool head mating end 40. The female end 24 is preferably hexagonal in cross section although any eccentric shape may be used to ensure that the external surfaces of the pneumatic drive assembly 11 and tool heads 12, 13, or 14 do not rotate relative to one another when mated. Locking bearings 25 consisting of spherical, ball-bearing-like elements are provided adjacent the interior surface 30 of the female end 24. The bearings 25 are held in apertures 26 formed in the interior surface 30 which are slightly smaller in diameter than the diameter of the bearings 25 such that when the bearings 25 are inserted from behind the interior surface, the bearings 25 protrude outward from the surface 30 of the female end 24 but are prevented from complete passage through apertures 26. The locking bearings 25 are biased toward the interior of the female end 24 via a spring (not shown in FIG. 2) discussed infra. The pneumatic drive assembly drive shaft 23 is shown at the center of the female end 24. The drive shaft 23 is in communication with the rotor/impeller (not shown) of the pneumatic drive assembly, and its drive shaft male end 31 is accommodated by the corresponding female end 44 in the tool heads 12, 13, or 14 when the device 10 is assembled for use. Like the female end 24 discussed above, the drive shaft male end 31 is hexagonal in cross section but any eccentric shape will suffice to ensure that the drive shaft male end 31 and the rotating elements of the respective tool heads 12, 13, or 14 rotate in concert.

The proximal end 41 of any of the tool heads 12, 13, or 14 is also shown in FIG. 2 with the tool head mating end 40 mounted proximally in relation thereto. The tool head mating end 40 further comprises the tool head shank 42 with male end 43 having exterior dimensions corresponding to the interior dimensions of the female end 24 of the pneumatic drive mating end 20. A tool head drive shaft female end 44 is provided on the tool head mating end 40, coaxially inside the tool head shank 42, and is sized to accommodate the drive shaft male end 31 of the pneumatic drive mating end 20. The drive shaft female end 44 is free to rotate and is in communication with the rotating elements of tool heads 12, 13, or 14 (not shown). An arcuate locking channel 50 is formed in the tool head shank 42, the channel 50 having a radius sized to hold the locking bearings 25 of the pneumatic drive mating end 20.

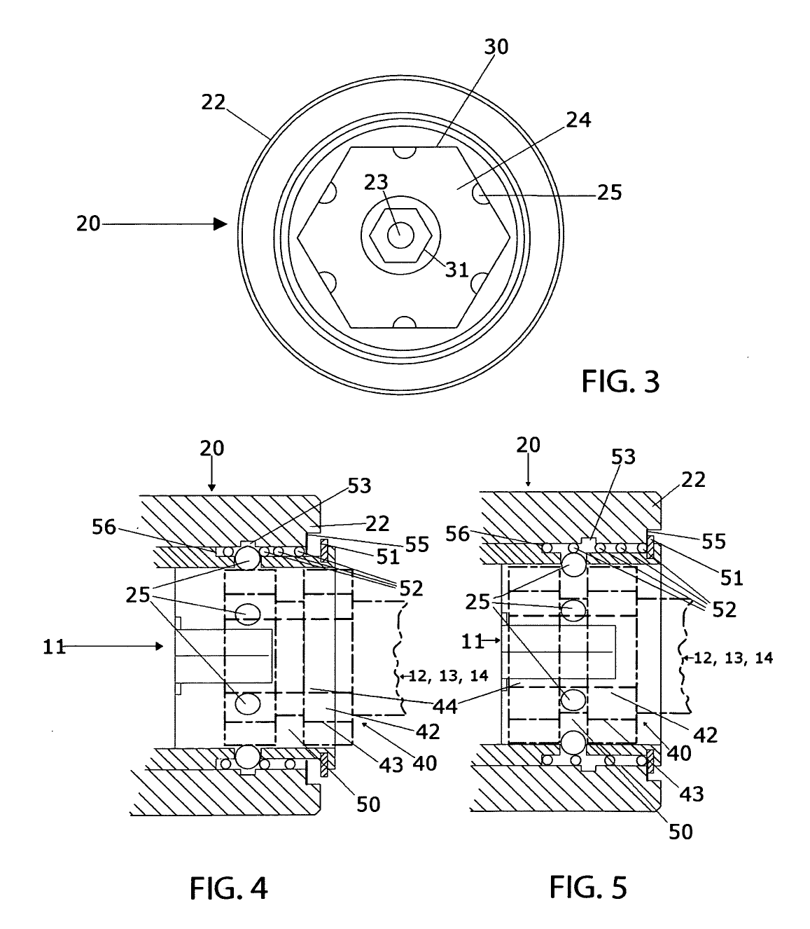

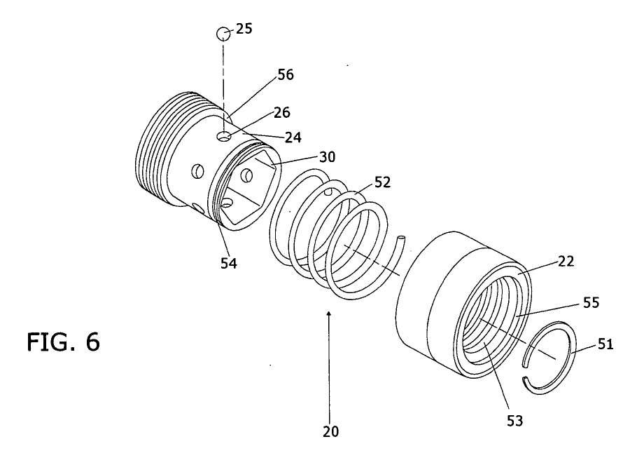

FIG. 3 shows the front end of the pneumatic drive mating end 20 with its locking bearings 25 in their locked position. In FIGS. 4 and 5, mating of the tool 10 is shown. FIGS. 4 and 5 are cutaway schematics showing the mated pneumatic drive assembly 11 (more specifically, its pneumatic drive mating end 20) mated with a tool head 12, 13, or 14 (more specifically, a tool head mating end 40). FIG. 4 shows the apparatus just prior to locking and FIG. 5 shows the same apparatus fully mated and ready for use. As shown in FIG. 4, the locking ring 22 is biased against a circumferential coil spring 52 held in position via first and second spring retaining lips 55, 56. Withdrawing/retracting the lock ring 22 exposes an annular unlocking channel 53 formed on the interior surface of the locking ring. Thereafter, insertion of the tool head mating end 40 causes the locking bearings 25 to retract into the unlocking channel 53 such that they cannot impinge insertion of the respective tool head 12, 13, or 14. As shown in FIG. 5, once the tool head 12, 13, or 14 is fully seated, the locking ring 22 is released and the coil spring 52 biases the locking ring 22 forward. A split ring 51, as seen in perspective in FIG. 6, abuts the step formed in the locking ring to prevent further movement within locking ring 22, at which point the unlocking channel 53 has been moved from alignment with the locking bearings 25 with the result that the bearings 25 are now forced into the locking channel 50 of the tool head mating end 40 thereby locking the mating end in place.

FIG. 6 is an exploded view of various elements of the pneumatic drive mating end 20 showing the relative position of each element. Notable elements and assembly steps include its female end 24 showing the apertures 26 therein for accommodating the locking bearings 25. As noted above, coil spring 52 is positioned over the female end 24 such that it encircles same and rests on the second spring retaining lip or step 56. The locking ring 22 is subsequently positioned over this combination so that the other end of the coil spring 52 bears against the first spring retaining lip or step 55, thus holding locking bearings 25 and coil spring 52 captive. A split ring 51 is then fastened about the annular split ring channel 54 formed in the exterior surface of the female end 24 in order to secure the apparatus.

In use, the user simply retracts the locking ring 22 of the pneumatic drive mating end 20 proximally so that the locking bearings 25 are free to move. Insertion of the tool head mating end 40 causes the bearings 25 to retract into the unlocking channel 53. Once seated, the locking ring 22 is released and pressure from the coil spring 52 causes it to return to its original position, simultaneously moving the unlocking channel 53 away from alignment with the locking bearings 25 and thus forcing the aforementioned bearings 25 back into their locked position. When a tool head 12, 13, or 14 is seated, the locking channel 50 of the tool head mating end 40 is locked in place such that the male end 43 of the tool head shank 42 is accommodated within female end 24 of the pneumatic drive mating end 20 and the pneumatic drive assembly 11 and tool heads 12, 13, or 14 are locked together and cannot rotate relative to one another. Similarly, the drive shaft male end 31 of the pneumatic drive assembly drive shaft 23 is accommodated within the tool head drive shaft female end 44 such that they are locked together and cannot rotate relative to one another. The apparatus 10 is now locked together and ready for use. One need only ensure that a supply of air is provided and the various cutting, polishing, drilling, grinding, etc. operations may be commenced. In operation, compressed gas enters the proximal end of the pneumatic drive assembly 11, thereby causing rotation of the rotor/impeller therein. The impeller is in communication with the drive shaft 23 of the pneumatic drive assembly, which is now interlocked with the corresponding tool head drive shaft female end 44 of the selected tool head 12, 13, or 14, such that, in order, rotation of the impeller causes rotational motion of the drive shaft 23, which in turn causes rotation of the tool head drive shaft female end 44. The tool head drive shaft female end 44 is in communication with the operational elements of the tool, for example, its drill head, die grinder head, or ratchet head such that work may now be performed.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1) A multi-function pneumatic tool with a plurality of removable tool heads capable of performing different functions comprising:
a pneumatic drive assembly having a drive assembly distal portion, a drive assembly proximal portion, and a pneumatically driven driveshaft transecting said drive assembly distal portion and said drive assembly proximal portion, said drive assembly distal portion including a pneumatic drive mating end for engagement with a selected tool head;
each pneumatic tool head having a tool head distal portion, a tool head proximal portion, and tool head driveshaft in communication with said tool head distal portion and said tool head proximal portion, said tool head proximal portion including a tool head mating end;
coupling means whereby said pneumatic drive mating end and said tool head mating end are releasably coupled, said coupling means comprising a plurality of locking bearings retractably mounted adjacent the interior surface of said pneumatic drive mating end and an arcuate locking channel sized to accommodate said locking bearings, said arcuate locking channel being formed on the exterior surface of said tool head mating end.

2) (canceled)

3) A multi-function pneumatic tool as claimed in claim 1 wherein said interior surface of said pneumatic drive mating end defines a female end and said exterior surface of said tool head mating end forms a male end.

4) A multi-function pneumatic tool as claimed in claim 1 wherein said pneumatic drive mating end defines an interior that is hexagonally shaped in cross section and said tool head mating end is complimentarily hexagonally shaped in cross section.

5) A multi-function pneumatic tool as claimed in claim 1 wherein said pneumatic drive mating end defines an interior that is eccentric in cross section and said tool head mating end is complimentarily eccentric in cross section.

6) A multi-function pneumatic tool as claimed in claim 1 wherein said tool head is chosen from the group consisting of a drill tool head, a die grinder tool head, and a ratchet tool head.

7) A multi-function pneumatic tool as claimed in claim 1 wherein said tool head is a rotating tool head.

8) A multi-function pneumatic tool as claimed in claim 1 wherein said tool head is chosen from the group consisting of a cut-off tool tool head, a circular saw tool head, a circular sander tool head, and an impact wrench tool head.

9) An interchangeable tool head pneumatic tool comprising:
a pneumatic drive assembly having a drive assembly distal portion, a drive assembly proximal portion, and pneumatically driven driveshaft transecting said drive assembly distal portion and said drive assembly proximal portion, said drive assembly distal portion including a pneumatic drive hexagonally shaped mating end;
a removable pneumatic tool head having a tool head distal portion, a tool head proximal portion, and tool head driveshaft in communication with said tool head distal portion and said tool head proximal portion, said tool head proximal portion including a complimentary hexagonally shaped tool head mating end;
coupling means whereby said pneumatic drive mating end and said tool head mating end are releasably coupled; and,
said coupling means including a plurality of locking bearings retractably mounted adjacent the interior surface of said pneumatic drive mating end and an arcuate locking channel sized to accommodate said locking bearings, said arcuate locking channel being formed on the exterior surface of said tool head mating end.

10) A pneumatic tool as claimed in claim 9 wherein an interior surface of said pneumatic drive mating end defines a female end and an exterior surface of said tool head mating end forms a male end.

11) (canceled)

12) (canceled)

13) A pneumatic tool as claimed in claim 9 wherein said tool head is chosen from the group consisting of a drill tool head, a die grinder tool head, and a ratchet tool head.

14) A pneumatic tool as claimed in claim 9 wherein said tool head is a rotating tool head.

15) A pneumatic tool as claimed in claim 9 wherein said tool head is chosen from the group consisting of a cut-off tool head, a circular saw tool head, a circular sander tool head, and an impact wrench tool head.

16) An interchangeable tool head pneumatic tool comprising:
a pneumatic drive assembly having a drive assembly distal portion, a drive assembly proximal portion, and pneumatically driven driveshaft transecting said drive assembly distal portion and said drive assembly proximal portion, said drive assembly distal portion including a pneumatic drive mating end;
a removable pneumatic tool head taken from a group consisting of a drill tool head, a die grinder tool head and a ratchet tool head having a tool head distal portion, a tool head proximal portion, and tool head driveshaft in communication with said tool head distal portion and said tool head proximal portion, said tool head proximal portion including a tool head mating end;
coupling means whereby said pneumatic drive mating end and said tool head mating end are releasably coupled;
said coupling means including a plurality of locking bearings retractably mounted adjacent the interior surface of said pneumatic drive mating end and an arcuate locking channel sized to accommodate said locking bearings, said arcuate locking channel being formed on the exterior surface of said tool head mating end; and,
said pneumatic drive mating end defining a female end that is hexagonally shaped in cross section and said tool head mating end defining a male end that is complimentarily hexagonally shaped in cross section.

17) (canceled)

18) A pneumatic tool as claimed in claim 16 wherein said tool head group includes is a rotating tool tool head.

19) A pneumatic tool as claimed in claim 16 wherein said tool head group includes a cut-off tool tool head, a circular saw tool head, a circular sander tool head, and an impact wrench tool head.
